(19) United States
(12) Patent Application Publication
(10) Pub. No.: US 2025/0159317 A1
(43) Pub. Date: May 15, 2025

(54) THERMAL SENSOR IMAGE AUGMENTATION FOR OBJECT DETECTION

(71) Applicant: Faurecia IRYStec Inc., Montreal (CA)

(72) Inventors: Pranjay Shyam, Montreal (CA); Hyunjin Yoo, Nepean (CA); Tara Akhavan, Paris (FR)

(21) Appl. No.: 18/509,782

(22) Filed: Nov. 15, 2023

(51) Int. Cl. H04N 23/15; B60R 1/30; G06T 3/4061; H04N 23/11; H04N 23/60; H04N 23/61

(52) U.S. Cl. CPC H04N 23/15; B60R 1/30; G06T 3/4061; H04N 23/11; H04N 23/61; H04N 23/64

(57) ABSTRACT

A system and method is provided for of detecting an object within an image. The method includes: obtaining a thermal image captured by a thermal image sensor; upsampling the thermal image using a super-resolution technique to generate an upsampled thermal image; and detecting an object within the upsampled thermal image through inputting the upsampled thermal image into a visible light object detector configured to detect objects within image data within a visible light color space.

### TECHNICAL FIELD

This disclosure relates to methods and systems for detecting objects within a field of view of an image sensor, particularly augmenting image object detection using thermal images captured by a thermal image sensor.

### BACKGROUND

Camera images are commonly used for detecting objects, and oftentimes attributes about those objects, for various purposes, such as for aiding a vehicle in autonomous navigation or identifying objects within a field of view for a viewer. Depending on the scenario in which the camera is used, the images captured by the camera may have degradations due to sun flare or weather conditions such as rain, low light, etc. Such degradations affect object detection performed on such visible light images, such as RGB images. Thermal images may be used generally to perform object detection, but systems employing such thermal imaging suffer from slower or otherwise degraded performance as multiple object detection networks and pipelines are employed for detecting objects within such visible light and thermal images.

### SUMMARY

According to one aspect of the disclosure, there is provided a method of detecting an object within an image. The method includes: obtaining a thermal image captured by a thermal image sensor; upsampling the thermal image using a super-resolution technique to generate an upsampled thermal image; and detecting an object within the upsampled thermal image through inputting the upsampled thermal image into a visible light object detector configured to detect objects within image data within a visible light color space.

According to various embodiments, the method may further include any one of the following features or any technically-feasible combination of some or all of the features:
the visible light object detector is configured to detect objects within a visible light image captured by a visible light sensor, the thermal image captured by the thermal image sensor, or both the visible light image and the thermal image;
further comprising the step of: capturing a visible light image and inputting the visible light image into the visible light object detector in order to detect one or more objects located within the visible light image;
the visible light image includes at least three visible light channels;
wherein at least three visible light channels include one or more of the following: a red channel, a green channel, a blue channel;
the upsampled thermal image is projected to the visible light color space using a projection function to generate a projected thermal image, and wherein the projected thermal image is used as the upsampled thermal image for object detection;
the projected thermal image is combined with a visible light image in order to detect an object visible within a shared field of view, and wherein the shared field of view is a field of view defined by overlapping of a field of view of the thermal image sensor and a field of view of a visible light sensor used to capture the visible light image;
further comprising the steps of: capturing a visible light image using a visible light sensor; and determining whether the visible light is degraded, wherein the upsampled thermal image is used for object detection when it is determined that the visible light image is degraded, and wherein the visible light image is used for object detection when it is determined that the visible light image is not degraded; and/or
the visible light object detector includes a bidirectional feature pyramid network and an object detector head.

According to another aspect of the disclosure, there is provided a method of detecting an object within an image. The method includes: obtaining a visible light image captured by a visible light sensor; determining whether the visible light is degraded; when it is determined that the visible light image is degraded: (i) upsampling a thermal image using a super-resolution technique to generate an upsampled thermal image; (ii) projecting the upsampled thermal image into a visible light color space to generate a projected thermal image; and (iii) detecting an object within the projected thermal image through inputting the projected thermal image into a visible light object detector; and when it is determined that the visible light image is degraded, detecting an object within the visible light image through inputting the visible light image into the image object detector.

According to yet another aspect of the disclosure, there is provided a thermal-augmented image object detection system having a visible light sensor configured to capture a visible light image; a thermal image sensor configured to capture a thermal image; and a computer subsystem having at least one processor and memory storing computer instructions that, when executed by the at least one processor, cause the thermal-augmented image object detection system to: (i) upsample the thermal image using a super-resolution technique to generate an upsampled thermal image; and (ii) detect an object within a shared field of view by inputting one or both of the visible light image and the upsampled thermal image into a visible light object detector configured to detect objects within image data within a visible light color space.

According to various embodiments, the thermal-augmented image object detection system may further include any one of the following features or any technically-feasible combination of some or all of the features:
the computer subsystem is further configured so that, when the computer instructions are executed by the at least one processor, the thermal-augmented image object detection system determines whether the visible light is degraded; and, when it is determined that the visible light image is degraded, to perform upsampling of the thermal image to generate the upsampled thermal image and to input the upsampled thermal image into the visible light object detector in order to detect objects;
the computer subsystem is further configured so that, when the computer instructions are executed by the at least one processor, the thermal-augmented image object detection system inputs the visible light image into the visible light object detector in order to detect objects;
the shared field of view is a field of view defined by overlapping of a field of view of the thermal image sensor and a field of view of a visible light sensor used to capture the visible light image;
the visible light image includes at least three visible light channels;
wherein at least three visible light channels include one or more of the following: a red channel, a green channel, a blue channel;
the upsampled thermal image is projected to the visible light color space using a projection function to generate a projected thermal image, and wherein the projected thermal image is used as the upsampled thermal image for object detection;
the projected thermal image is combined with a visible light image in order to detect an object visible within the shared field of view, and wherein the shared field of view is a field of view defined by overlapping of a field of view of the thermal image sensor and a field of view of a visible light sensor used to capture the visible light image;
the thermal-augmented image object detection system incorporated into vehicle electronics of a vehicle; and/or
the thermal-augmented image object detection system incorporated into an advanced driver assistance system (ADAS) for a vehicle.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating a thermal-augmented image object detection system, according to one embodiment;

FIG. 2 is a flowchart illustrating a method of detecting an object within an image, according to one embodiment;

FIG. 3 is a block diagram illustrating a thermal-augmented image object detection pipeline, according to one embodiment; and

FIG. 4 is a block diagram depicting a lightweight super-resolution framework implementing a lightweight super-resolution technique used to upsample thermal images to a higher resolution, according to embodiment;

FIG. 5 is a block diagram depicting a real time super-resolution block layer used as a part of the super-resolution framework of FIG. 4;

FIG. 6 is a block diagram depicting a multi-scale feature extraction module used as a part of the real time super-resolution block layer of FIG. 5;

FIG. 7 is a block diagram depicting a visible light object detector having a bidirectional feature pyramid network and an object detector head;

FIG. 8 is a flowchart illustrating a method of training a thermal-augmented image object detection pipeline, according to one embodiment; and

FIG. 9 is a block diagram illustrating a vehicle operating environment having a thermal-augmented image object detection system onboard a vehicle, according to one embodiment.

### DETAILED DESCRIPTION

A system and method is provided for detecting an object within a thermal image, which may be useful for supplementing or augmenting object detection performed on a visible light image. The system, which is referred to as a thermal-augmented image object detection system, includes a visible light sensor (camera), a thermal image sensor (e.g., an infrared detector configured to sense passive light emanating from objects), and a computer subsystem configured to detect objects within visible light images captured by the visible light camera and thermal images captured by the thermal image sensor. In particular, a thermal sensor image is used to augment detection of objects when the visible light image is degraded. The thermal image is converted to an image resolution and color space of the visible light image, thereby allowing a shared image object detector to be used for detecting objects within both a visible light image and a thermal image.

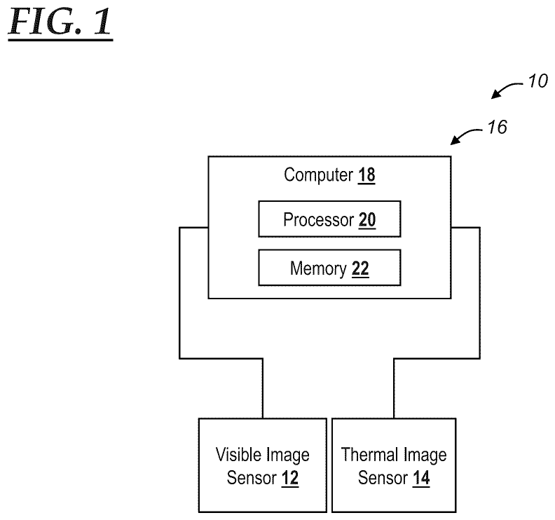

With reference to FIG. 1, there is shown a thermal-augmented image object detection system 10 having a visible light sensor 12, a thermal image sensor 14, and a computer subsystem 16 having at least one computer 18, which includes at least one processor 20 and memory 22.

The visible light sensor 12 is a light sensor that captures visible light represented as an array of pixels that together constitute a visible light image. The visible light sensor 12 is a camera that captures and represents a scene using a visible light color space or domain, such as RGB. According to embodiments, the visible light sensor 12 is a digital camera, such as one employing a CMOS (Complementary Metal-Oxide-Semiconductor) sensor, CCD (Charge-Coupled Device) sensor, and Foveon sensor.

The visible light sensor 12 captures visible light images representing a scene as viewed from the sensor's point of view. More particularly, the visible light sensor 12 receives light, which is then converted from its analog representation to a digital representation. Various processing techniques may be used to prepare the visible light image for downstream processing, including, for example, demosaicing, color space conversion, and other image processing techniques, such as image enhancement techniques (e.g., color balance, exposure, sharpness). Such processing results in the captured light represented as a visible light image in a visible light color space, such as standard RGB (sRGB) or Adobe™ RGB, for example.

The thermal image sensor or thermal camera 14 is a sensor that captures electromagnetic waves emitted from objects within its field of view (FOV), such as a passive infrared sensor capable of sensing infrared and/or near-infrared light. The thermal image sensor 14 may be a forward looking infrared (FLIR) sensor and may receive infrared radiation emitted by objects at its sensor or infrared detector, which then converts electrical signals excited by said radiation into digital form so as to generate a thermal image representing received radiation intensity using a single channel, such as a grayscale channel. The thermal image may undergo pre-processing, such as noise reduction, contrast enhancement, and calibration, to improve the accuracy and reliability of the captured information. The infrared detector of the thermal image sensor 14 may be a microbolometer, for example, which is preferable in many applications for its compactness, reliability, and low cost. Common resolutions for such thermal image sensors include 320×240 and 640×480, although others are of course possible. The resolution of the thermal image sensor 14 is less than the resolution of the visible light sensor 12.

The visible light sensor 12 and the thermal image sensor 14 are disposed very close to one another and oriented in the same manner so that the visible light sensor 12 and the thermal image sensor 14 share a field of view, at least to a great extent (i.e., over 95% of the FOV of the visible light sensor 12 overlaps with the FOV of the thermal image sensor 14). This reduces the calibration used for aligning visible light images captured by the visible light sensor 12 and thermal images captured by the thermal image sensor 14, as such images are to be processed for detecting objects within a shared FOV.

The computer subsystem 16 is for processing the visible light images captured by the visible light sensor 12 and thermal images captured by the thermal image sensor 14. The computer subsystem 16 is configured to perform the method discussed herein, and is configured to do so through executing computer instructions. The computer subsystem 16 includes the at least one computer 18. In FIG. 1, a single computer 18 is illustrated, although it will be appreciated that multiple computers may be used as the at least one computer 18, together configured to perform the method and any other functionality attributed to the computer subsystem 16, as described herein. Each of the at least one computer 18 includes the at least one processor 20 and memory 22, with the memory 22 storing the computer instructions for execution by the at least one processor 20. It will also be appreciated that the computer instructions may be stored on different physical memory devices and/or executed by different processors or computers of the computer subsystem 16, together causing performance of the method and attributed functionality discussed herein.

In one embodiment, the at least one processor 20 includes a central processing unit (CPU) and a graphics processing unit (GPU) (or even a tensor processing unit (TPU)), each of which is used to perform different functionality of the computer subsystem 16. For example, the GPU is used for inference of neural networks (or any like machine learning models) as well as for any training, such as online training carried out for adaptable learning carried out after initial deployment; on the other hand, other functionality attributed to the computer subsystem 16 is performed by the CPU. Of course, this is but one example of an implementation for the at least one computer 18, as those skilled in the art will appreciate that other hardware devices and configurations may be used, oftentimes depending on the particular application in which the at least one computer 18 is used.

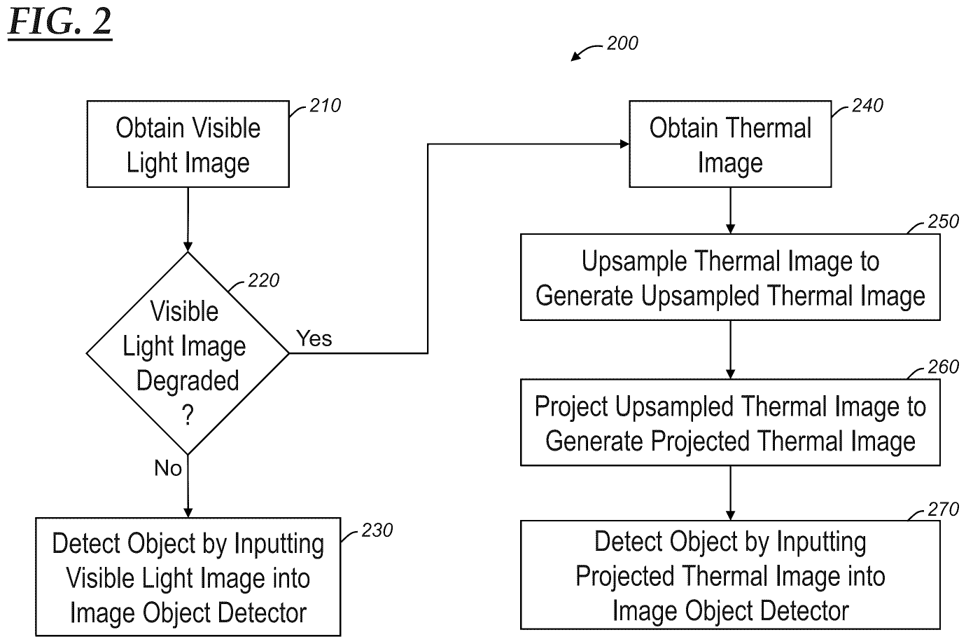

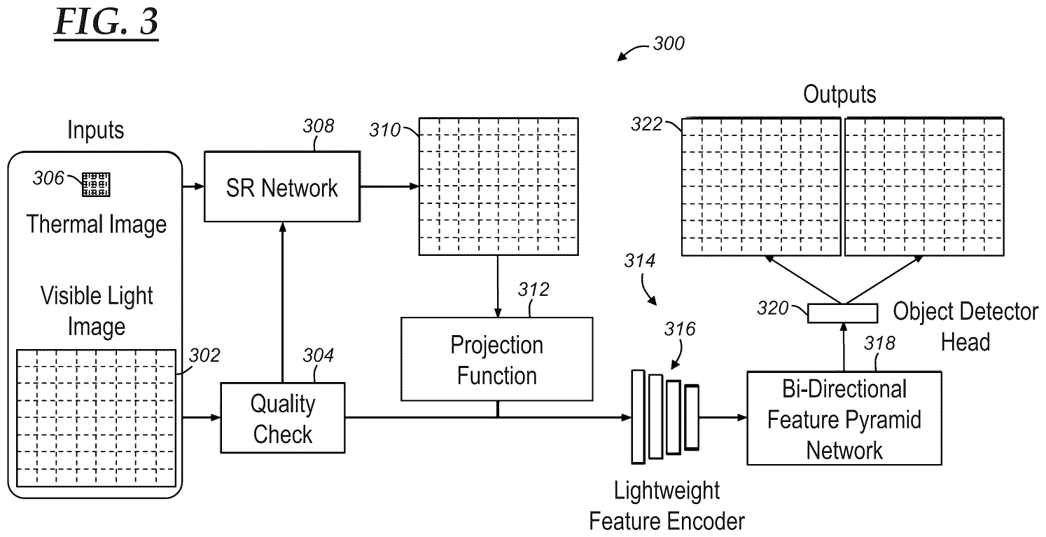

With reference to FIGS. 2-3, there is shown a method 200 of detecting an object within an image (FIG. 2), which is performed by a thermal-augmented image object detection pipeline 300 (FIG. 3). The method 200 is performed by the thermal-augmented image object detection system 10 through implementing the thermal-augmented image object detection pipeline 300, according to one embodiment.

The method 200 begins with step 210, wherein a visible light image is obtained. The visible light image is captured using the visible light sensor 12. The visible light sensor 12 may continuously capture visible light images that are then processed and/or stored in memory of the system 10. The visible light sensor 12 captures visible light information of a scene within the FOV of the visible light sensor 12, which includes an area or region that is being monitored for objects. The visible light image is obtained at the at least one computer 18 and may be processed using various techniques, such as image enhancement techniques. FIG. 3 depicts a visible light image 302 that is captured by the visible light sensor 12. In one example, the visible light image 302 has a resolution of 4 megapixels (MP); however, it should be appreciated that visible light sensors having other resolutions may be used, such as those having 1 or 2 MP (e.g., 1280×720), 8 MP (e.g., 3840×2160), or even higher resolutions. The method 200 continues to step 220.

In step 220, it is determined whether the visible light image is degraded. It will be appreciated that images captured in different applications and environments experience different kinds and/or extents of degradation and, accordingly, those skilled in the art will appreciate that the particular degradation criterium or criteria used to determine whether the visible light image is degraded may vary from application to application. In the context of an onboard vehicle environment whereby the thermal-augmented image object detection system 10 is implemented onboard a vehicle (as is the case with thermal-augmented image object detection system 800 (FIG. 9), discussed below), weather-based degradation may be targeted for this step. FIG. 3 has a quality check module 304 that is used to perform this step 220.

Weather-induced corruptions or degradations, including flare, snow, fog, rain, and low-light scenarios, often lead to over-saturation thereby creating regions of intense brightness within the visible light image. Capitalizing on this insight, a straightforward yet effective strategy is introduced for detecting and identifying degradations. More particularly, in the present embodiment, a basic filter is employed to identify distinctive peaks in the intensity histogram of the RGB image. These peaks, indicative of the predominant intensity values, are averaged to determine the highest peak. Employing a thresholding mechanism (β₁, β₂), the visible light image is classified based on degradation, such as whether there is or is not a degradation and, in some embodiments, a type of degradation, such as an illumination degradation or a weather-induced degradation. Such a degradation technique provides a nimble means of preemptively assessing image quality, thus ensuring the robustness and accuracy of downstream object detection tasks, even under challenging weather conditions. Such a technique is represented below in Algorithm 1. From empirical evaluation, β₁ and β₂ may be fixed, such as to 180 and 20, respectively. Of course, other predetermined values may be empirically derived for the particular application or use case in which the method 200 is to be used. When a degradation is detected (e.g., “Weather Degradation” or “Illumination Degradation” are identified using Algorithm 1), the method 200 continues to step 240; otherwise, the method 200 proceeds to step 230.

Algorithm 1 Weather Degradation Identification

| | |
|---|---|
| 1: | Input ← RGB image |
| 2: | Convert RGB image to grayscale using luminance con- |
| | version. |
| 3: | Apply median filter to reduce noise |
| 4: | Compute image intensity histogram |
| 5: | Find the peaks in the histogram |
| 6: | Sort the peaks in ascending order |
| 7: | Compute the average intensity value of the highest peak |
| 8: | Set a threshold for weather (β₁) and Illumination |
| | degradation β₂ |
| 9: | if average intensity value ≥ β₁ then |
| 10: | Return → Weather Degradation |
| 11: | else if average intensity value ≤ β₂ then |
| 12: | Return → Illumination Degradation |
| 13: | else |
| 14: | Return → No Significant Weather Degradation |
| 15: | end if |

In step 230, an object is detected by inputting the visible light image into an image object detector. As shown in the embodiment of FIG. 3, the visible light image 302 is passed into an image object detection pipeline 314 having a lightweight feature encoder 316, a bidirectional feature pyramid network (FPN) 318, and an object detection head 320. The thermal-augmented image object detection pipeline 300 is shared for both visible light and thermal image object detection. Indeed, at least in some embodiments, the image object detection pipeline implements an image object detector configured to detect objects within an image encoded according to a visible light color space, such as sRGB represented by a red channel, a green channel, and a blue channel that define the visible light color space in this example. An output of the image object detection pipeline 300 is provided, indicating whether an object was detected and, in at least some embodiments, attributes of the detected object, such as, for example, a classification of object (e.g., pedestrian, dog, vehicle, tree), its spatial presence within the visible light image (e.g., segmented by one or more polygons defined with pixel coordinates as vertices), etc. The method 200 then ends.

In step 240, a thermal image is obtained, where the thermal image is captured by the thermal image sensor. It will be appreciated that thermal images may continuously be captured and/or stored in memory of the system 10, but use of a particular thermal image is dependent on step 220, at least in the present embodiment. The thermal image sensor 14 captures infrared radiation of a scene within the FOV of the thermal image sensor 14, which includes a shared FOV being a FOV defined by an overlap of the FOV of the visible light sensor 12 and the FOV of the thermal image sensor 14. As used herein, the term “infrared radiation” covers electromagnetic radiation having wavelengths in the 0.5 μm to 1 mm, which includes near-infrared (NIR), mid-infrared (MIR), long-wavelength infrared (LWIR), and portions of far infrared (FIR). For example, the thermal image sensor 14 is configured to capture information from infrared radiation having a range between 5 μm to 100 μm. FIG. 3 depicts a thermal image 306 that is captured by the thermal image sensor 14. In one example, the thermal image 306 has a resolution of 206×156, but this may be even less for certain implementations, such as 80×60. In embodiments, higher resolutions may be used, such as 320×640, with the resolution of the thermal image sensor 14 being less than that of the visible light sensor 12. The method 200 continues to step 250.

In step 250, the thermal image is upsampled to generate an upsampled thermal image. The thermal image 306 is upsampled through use of a super-resolution module 308, which implements a super-resolution technique or function that interpolates or otherwise transforms a low resolution image into a higher resolution image, particularly into a high resolution thermal image that constitutes the upsampled thermal image. The thermal image 306 is upsampled so that it, once upsampled, has the same resolution as the visible light image, at least at the point when the visible light image is input into the image object detection pipeline 314 as cropping or other processing may be performed after capture and prior to input into the image object detection pipeline 314.

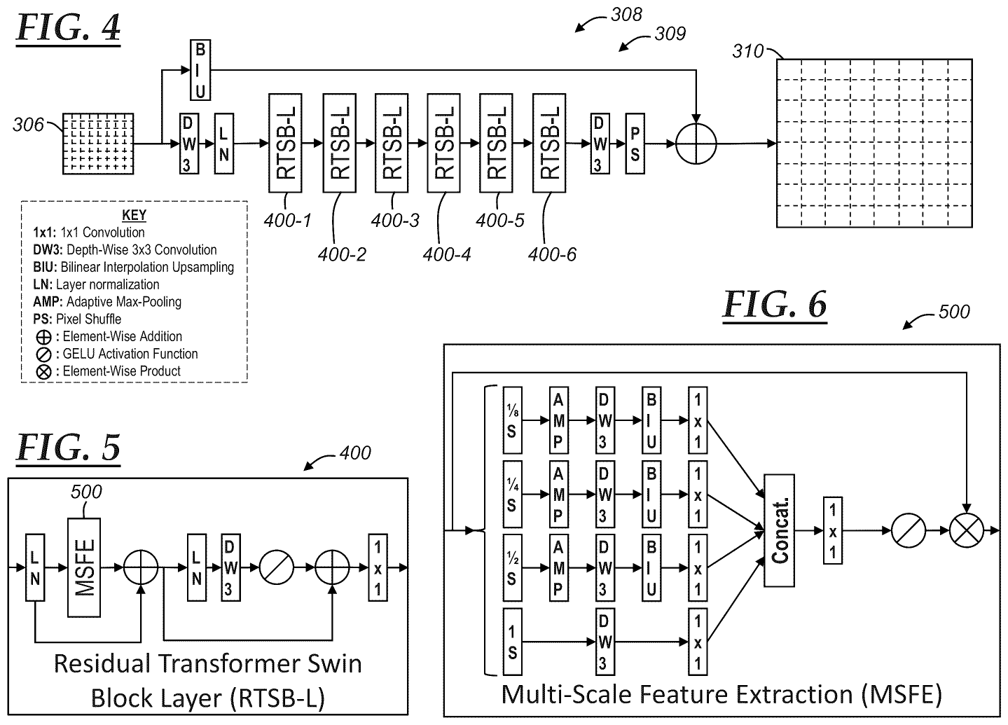

According to embodiments, a super-resolution technique as described below is used to upsample the thermal image to create the upsampled thermal image. With reference to FIGS. 4-6, a two-fold strategy is adopted to build upon the insights drawn from [47], which underscored the direct correlation between deep learning network inference speed and activation volume. Initially, the computational load of the super-resolution network was streamlined by tactically downsampling the input image across the channel dimension through strided convolution operations. This strategic spatial compression enhances computational efficiency. Recognizing the inherent ill-posed nature of low-resolution super-resolution problems [46-48], wherein multiple high-resolution solutions coexist, the prowess of transformer-based super-resolution architectures is harnessed for adeptly capturing intricate non-local feature correlations.

Nonetheless, the computational demands of transformer models are notorious, largely due to the quadratic complexity stemming from self-attention mechanisms. Addressing this hurdle, a convolution-based alternative to conventional self-attention is introduced, as discussed herein. This disclosed approach facilitates the extraction of multi-scale features that subsequently undergo dynamic feature selection. This dynamic selection technique ensures the assimilation of nonlocal feature interactions, which are then synergistically augmented with the power of convolutional channel mixture strategies [65]. This synergy enables the efficient extraction of pertinent local features. Collectively, this lightweight yet holistic framework emerges as a compelling solution for robust thermal image super-resolution under the complex influence of diverse weather conditions while simultaneously adhering to the imperative of computational efficiency for real-world applications.

In addressing the crucial need for capturing long-range dependencies while circumventing the computational challenges posed by self-attention mechanisms, a solution rooted in feature pyramid networks (FPNs) tailored to cater to diverse scales of contextual information is provided. This provided approach entails a multi-step process that effectively marries global and local feature integration. To elaborate, the process is kickstarted or initiated by constructing a robust FPN architecture leveraging channel splitting techniques, thereby facilitating the extraction of multi-scale features across four distinct scales (1, ½, ¼, and ⅛). These diverse scale-specific features are then refined through a judicious combination of operations that balance information preservation and computational efficiency.

In particular, a 3×3 depth-wise convolution is a pivotal element, allowing us to channel the extracted features into a transformative phase. This is followed by an adaptive nearest interpolation to homogenize feature dimensions across the scales. To amplify the richness of the fused features, a refined 1×1 convolution was employed, imparting the appropriate enhancement while preserving the computational economy paramount for real-world applicability. Significantly, this disclosed approach incorporates a Gaussian Error Linear Unit (GELU) activation function, acting as an enabler for introducing non-linearity, thereby fostering the intricate representations that are quintessential for robust feature extraction. This holistic methodology yields a feature-rich representation that encapsulates global context and fine-grained local information, all while circumventing the traditionally associated quadratic complexities of the self-attention mechanism.

In the disclosed approach, the standard feed-forward layer is replaced with a convolutional channel mixer to enhance further the local spatial modeling within the modified transformer block. Unlike prior works that proposed utilizing 1×1 convolutions or fully connected layer, the alternative mechanism uses 3×3 convolutions to expand features across channel dimensions followed by mixing operation. Finally, 1×1 convolution is applied to compress the feature space. An overview of the proposed super-resolution algorithm is discussed more below with reference to FIGS. 4-6.

FIG. 4 shows an embodiment of the super-resolution module 308 that implements a super-resolution pipeline 309 that transforms the input thermal image 306 into the upsampled thermal image 310. The super-resolution pipeline 309 uses depth-wise convolution followed by layer normalization and N number of Residual Transformer Swin Block layers (RTSB-L) 400-1 to 400-N, where N is the total number of RTSB-L in the pipeline 309 and, in the depicted embodiment of FIG. 4, is equal to 6. A Swin block is a primary component of the Swin Transformer architecture used for image processing, and includes a window-based self-attention mechanism where input images are partitioned into non-overlapping windows for localized attention computation, followed by multi-layer perceptrons (MLPs) (feedforward neural networks); both stages incorporate residual connections to facilitate gradient flow during training.

FIG. 5 depicts the RTSB-L 400 used for each of the RTSB-L 400-n (where n is an integer between 1 and N, inclusive of both bounds). In particular, in the depicted embodiment, the RTSB-L 400 begins with a layer normalization followed by multi-scale feature extraction (MSFE) 500, which is illustrated in FIG. 6, according to one embodiment. Following the MSFE 500, element-wise addition is performed on the output of the MSFE 500 and the output of the initial layer normalization of the RTSB-L 400. Following this element-wise addition, another layer normalization is performed, followed by a depth-wise 3×3 convolution, which is then passed into the GELU activation function. Element-wise addition is then performed on the output of this GELU activation function and the output of the previous or initial element-wise addition performed in the RTSB-L 400, finally followed by a 1×1 convolution.

FIG. 6 depicts the MSFE 500, according to one embodiment, which is used to extract features detectable at varying scales, namely four scales in the depicted embodiment: full scale (1 S), one-half scale (½ S), one-quarter scale (¼ S), and one-eight scale (⅛ S). The MSFE 500 considers four scales in the depicted embodiment, each defined by starting with full scale and stepping down by one half or 50%. Each of the scaled-down three (all but the one of the full scale) are then pooled using adaptive max pooling. Then, a depth-wise 3×3 convolution is performed on each, followed by a bilinear interpolation upsampling on each of the three scaled-down processes, and finally followed by a 1×1 convolution for each, including the full scale. The results of this 1×1 convolution are concatenated and then a 1×1 convolution is performed, followed by a GELU activation and element-wise product based on the result of the GELU activation and the input into the MFSE 500.

Turning back now to FIG. 4, following N back-to-back RTSB-L processing, a depth-wise 3×3 convolution is performed, followed by a pixel shuffle, the output of which is combined with the input as upsampled by bilinear interpolation upsampling using element-wise addition to produce the upsampled thermal image 310. Turning back now to FIGS. 2-3, the method 200 continues to step 260.

In step 260, the upsampled thermal image is projected into a visible light color space, particularly the visible light color space of the visible light image when input into the image object detection pipeline 314. This results in generating a projected thermal image with the same channels (and resolution as a result of step 250) as the visible light image 302, thereby enabling the same image object detection pipeline 314 to be used for detecting objects images captured by the visible light sensor 12 and the thermal image sensor 14.

In the realm of super-resolution for thermal images, the formidable challenge of executing robust object detection tasks while treading lightly on the computational front is confronted. Prior endeavors in this domain have typically resorted to employing distinct object detectors tailored to different modalities or adopting a concatenation strategy that combines RGB and thermal imagery. However, the disclosed approach steers in a different direction. The solution proposed here is to integrate thermal imagery into the object detection pipeline seamlessly. A learnable projection function is introduced that orchestrates the transformation of thermal image statistics into a format that seamlessly aligns with the RGB space. This operation is grounded in channel-wise mean-variance transfer. Mathematically, this projection is succinctly expressed as:

$${I}_{\overbrace{RGB}} = \frac{{I}_{HR}^{T} - {μ}_{{I}_{HR}^{T}}}{{σ}_{{I}_{HR}^{T}}} \cdot σ + μ \qquad Equation ( 1 )$$

where I_{HR}^{T} represents the input high resolution thermal image, while μ_{I}_{_{HR}}_{^{T}} and σ_{I}_{_{HR}}_{^{T}} correspond to its mean and standard deviation, respectively. For each channel in the R, G, B space, parameters σ, μ are learnable parameters. To ensure that optimizing these parameters does not break the training cycle due to boundary conditions when σ=0, a fixed bias of 1e-3 is included. The resultant [symbol] , which may be referred to as the projected thermal image, is an image that faithfully encapsulates the thermal characteristics within the RGB domain. By performing this translation in statistics, a single, unified object detector—a detector that remains invariant to the input modality—is able to be used for object detection of objects appearing in both visible light images and thermal images. This disclosed technique not only simplifies the computational complexity, but also elevates the robustness and versatility of the object detection system. The method 200 continues to step 270.

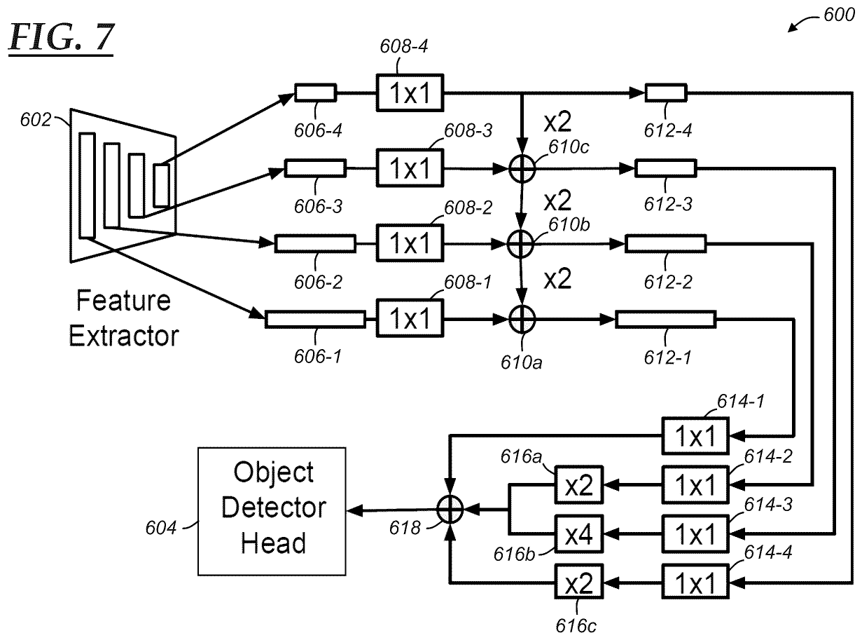

In step 270, an object is detected within the projected thermal image through inputting the projected thermal image into an image object detector configured to detect objects within image data. The object detector is a visible light object detector configured to detect objects within images within a visible light color space, such as RGB. Indeed, both the visible light image obtained in step 210 and the projected thermal image generated in step 260 are each an image in a visible light color space and are suitable inputs for the visible light object detector. Various visible light object detectors may be used, including the one described below and shown in FIG. 7.

In embodiments, only the projected thermal image is used to detect objects through use of the visible light object detector. However, in some embodiments, the projected thermal image and the visible light image are combined, such as through alpha blending, in order to generate a composite image within a visible light color space and this composite image is then input into the object detector in order to detect objects. As discussed above, the visible light sensor and the thermal image sensor may be positioned and oriented similarly so as to have a large overlapping field of view, which is referred to as a shared field of view. That is, the projected thermal image is combined with a visible light image in order to detect an object visible within the shared field of view.

FIG. 7 depicts an exemplary visible light object detector 600 having a bidirectional feature pyramid network (FPN) 602 and an object detection head 604, and this visible light object detector 600 is usable as a part of the image object detection pipeline 314. The bidirectional FPN 602 includes a plurality of network layers 606-k, where k is 1 to K with K being the total number of network layers in the bidirectional FPN 602, which is four (4) in the depicted embodiment of FIG. 7 (K=4).

A Feature Pyramid Network (FPN) is used to identify objects across various scales and resolutions within an image, and the FPN achieves this by establishing a multi-scale, pyramidal hierarchy of feature maps. The construction of this pyramid entails a bottom-up pathway in which lower-level (shallow) feature maps, containing fine-grained spatial information, are successively coarsened to create semantically richer, high-level feature maps. Subsequently, a top-down pathway is employed, where these high-level feature maps are upsampled and then laterally connected to their lower-level counterparts. This procedure ensures that the resulting feature maps at each level of the pyramid embody a blend of high-level semantic information and low-level spatial detail, equipping the network to detect objects of diverse sizes adeptly.

The bidirectional FPN 602 is a FPN with modifications to improve the feature representation within the single-stage object detectors while requiring less computation. Specifically, 1×1 convolutions 608-k are performed on multi-scale features before upsampling, resulting in the same output resolution as traditional FPN while consuming fewer parameters and floating point operations. Outputs of the 1×1 convolutions 608-k are upsampled and combined using element-wise addition 610a-c to output of the 1×1 convolutions 608-k of the previous network layer; for example, the output of the 1×1 convolution 608-4 for the fourth layer (represented as output 612-4) is combined with output of the 1×1 convolution 608-3 for the third layer in order to produce an output (represented as output 612-3) at the third network layer that is based on both feature representations extracted by the 1×1 convolution 608-3 for both the third and fourth network layers, as shown by element-wise adder 610c. This output is then propagated backward to a previous network layer, the second network layer, which then combines this output with the output of the 1×1 convolution 608-2 for the second network layer, as shown by element-wise adder 610b. Likewise, this output of the element-wise adder 610b (represented as output 612-2) is then propagated backward to the first network layer whereat it is combined with the output of the 1×1 convolution 608-1 for the first network layer, as shown by element-wise adder 610a, to produce output 612-1 for the first network layer. This backward propagating feature results in feature extractions occurring in two directions forward through the FPN as is the case with FPNs and neural networks in general, and backward, a unique feature of the presently-disclosed FPN, which is aptly referred to as a bidirectional FPN. This results in a set of outputs 612-k at each of the K layers that considers features that considers output of deeper network levels, except for the last layer (here, the fourth network layer, where k=4) as this is the deepest network layer in the FPN 602, at least according to the present embodiment. These outputs 612-k where k is 1 to K−1 are each referred to as a bidirectional feature network output and, together along with the output 612-K (here 612-4), are referred to as a bidirectional feature network output set.

These outputs 612-k, which multi-scale features, are refined using a group-wise 1×1 convolution shown a 614-k. Outputs of these 1×1 convolutions 614-k are then upsampled as appropriate. Finally, instead of using multi-scale features for performing object detection, following prior real-time object detection algorithms [20, 23, 24, 49], the aggregated feature map is used to compute bounding box for objects of interest using the object detector head 604.

The object detection head 604 provides localization and classification of objects within an image, utilizing the multi-scale feature maps provided by the bidirectional FPN 602. First, the detection head employs bounding box regression to refine the position and size of predefined anchor boxes, ensuring a tight enclosure of the detected objects. Simultaneously, the object detection head 604 classifies each of these proposed regions, assigning class labels and confidence scores. In embodiments, the object detection head 604 may be specifically tailored for diverse scales of the feature pyramid, allowing for optimized detection of variously sized objects. Post-detection, a non-maximum suppression algorithm is typically invoked to curate the final set of detections, whereby overlapping boxes are consolidated, retaining only the most confident predictions. The method 200 then ends.

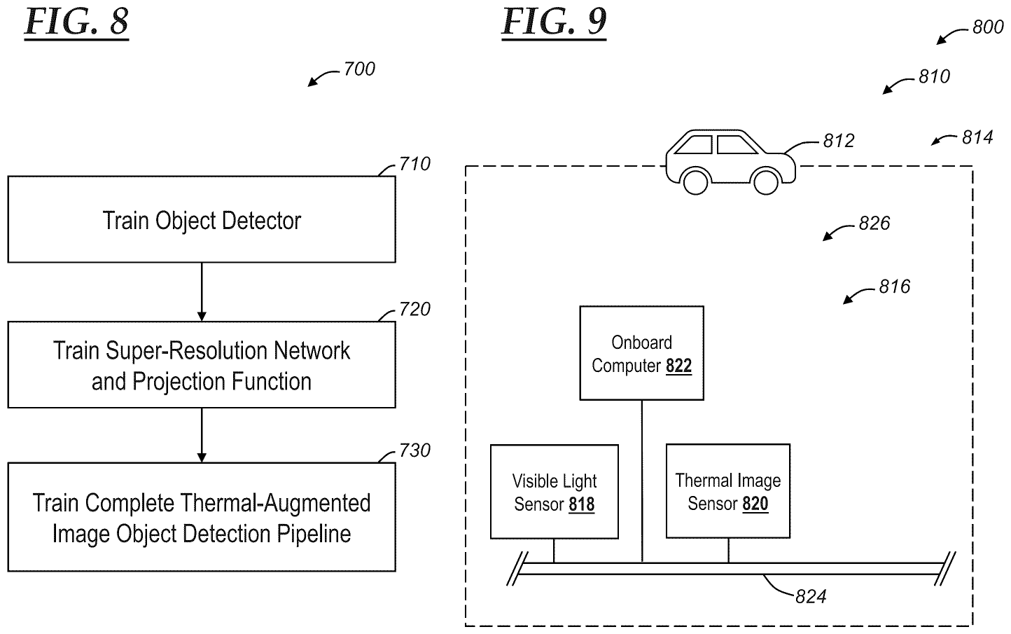

With reference to FIG. 8, there is shown a method 700 of training a thermal-augmented image object detection pipeline, such as the thermal-augmented image object detection pipeline 300 (FIG. 3) discussed above. The method 700 may be performed offline using a training computer, which is a computer that is configured for training an object detection pipeline, such as the thermal-augmented image object detection pipeline 300. Although the method 700 is described below as having steps 710-730 performed in a time-ordered manner starting with step 710 and ending with step 730, according to other embodiments, a different order may be used, such as where step 720 is performed prior to step 710, for example.

The method 700 begins with training the visible light object detector 600 on images from a forward-looking infrared (FLIR) dataset that are projected to a visible color space, such as RGB. Real-time models for object detection (RTMDet) built on the mmdetection framework. The object detector is trained using AdamW optimizer with: parameters β1=0.9, β₂=0.999; a learning rate of 4e-3; and a weight decay of 0.05 following a cosine annealing learning rate strategy for 300 epochs at an input resolution of 640×512. Of course, in other embodiments, the aforementioned training parameters may be adjusted and/or additional or different techniques may be used as well, sometimes dependent upon the application in which the object detector is to be used. The method 700 continues to step 720.

In step 720, the super-resolution network is trained along with the projection function while keeping the object detector fixed or frozen (not updating any weights thereof). For this training, a learning rate of 1e-3 adjusted via cosine annealing to 1e-5 is used and such training is carried out for 1000 epochs using Adam optimizer with parameters β1=0.9, β_{2=0.999}. For loss computation, a combination of L₁ and weighted fast Fourier transform (FFT) loss is used according to the following Equation:

$$L = {‖ SR ( {I}_{LR}^{T} ) - {I}_{HR}^{T} ‖}_{1} + λ * {‖ FFT ( SR ( {I}_{LR}^{T} ) ) - FFT ( {I}_{HR}^{T} ) ‖}_{1} \qquad Equation ( 2 )$$

Here, λ represents the weight parameter and is fixed to 0.1 based on empirical evaluation, although other values for this parameter may be empirically derived and used. Accordingly, in this step, the one or more learnable parameters of the projection function are trained along with one or more learnable parameters of the super-resolution function so that the super-resolution function and the projection function are trained together as a part of a single training task, according to the above Equation (2), for example. The method 700 continues to step 730.

In step 730, the complete or whole thermal-augmented image object detection pipeline is trained for 500 epochs using a mix or combination of visible light images and thermal images (e.g., from the FLIR dataset) with a learning rate of 1e-5 adjusted via cosine annealing to 1e-7 using Adam optimizer and a combined loss function for the object detection and super-resolution. It will be appreciated that the values discussed herein for training are exemplary and may be adjusted, and/or other training techniques may be employed as well, according to embodiments. The method 700 ends.

With reference now to FIG. 9, there is shown an operating environment 800 that comprises a communications system 810, which includes a vehicle 812 having vehicle electronics 814. The vehicle electronics 814 implements a thermal-augmented image object detection pipeline (such as the thermal-augmented image object detection pipeline 300) as a part of a thermal-augmented image object detection system 816. The thermal-augmented image object detection system 816 includes a visible light sensor 818, a thermal image sensor 820, an onboard computer 822, and an in-vehicle communications network 824 illustrated as a controller area network (CAN) bus 824 in FIG. 9. The thermal-augmented image object detection system 816 forms a part of an advanced driver assistance system (ADAS) 826 of the vehicle 812, leveraging the visible light sensor 818, the thermal image sensor 820, and the onboard computer 822 as well as various other hardware and software components not shown or described, but known in the art.

The vehicle 812 is depicted in the illustrated embodiment as a passenger car, but it should be appreciated that any other vehicle including motorcycles, trucks, sports utility vehicles (SUVs), recreational vehicles (RVs), bicycles, other vehicles or mobility devices that can be used on a roadway or sidewalk, etc., can also be used. The vehicle 812 includes the vehicle electronics 314, which may include various other components beyond those shown in FIG. 9, such as a wireless communication device or other network access device, an electronic display for displaying images in a visible light color space, one or more sensors, and controllers and various other hardware.

The visible light sensor 818 and the thermal image sensor 820 correspond to the visible light sensor 12 and the thermal image sensor 14 of the system 10 discussed above, and that discussion is hereby attributed to these components 818, 820, respectively and to the extent such discussion is not inconsistent with the express discussion of the components 818, 820. Likewise, the thermal-augmented image object detection system 816 corresponds to the thermal-augmented image object detection system 10, and that discussion is hereby attributed to the system 816 to the extent such discussion is not inconsistent with the express discussion of the system 816. And, likewise, the onboard computer 822 corresponds to the computer 18, and that discussion is hereby attributed to the onboard computer 822 to the extent such discussion is not inconsistent with the express discussion of the onboard computer 822.

The onboard computer 822 is “onboard” as it is carried by the vehicle 812 as a part of its vehicle electronics 814. Furthermore, in embodiments, the onboard computer 822 is a part of an ADAS 826 that uses various onboard vehicle sensors, actuators, and processing capabilities for purposes of assisting the driver or operator of the vehicle, such as providing adaptive cruise control, lane assist or keeping, and automatic emergency braking. The ADAS 826 employs vision sensors, such as visible light sensors and thermal sensors, for purposes of performing such assistive functionality. Robust sensing and decision-making is important for implementing such features appropriately in order to provide suitable and safe operation of the vehicle 812. Latency, especially when it comes to high-resolution image processing, is an important factor in addition to accuracy. The thermal-augmented image object detection system 816 enables enhanced or improved object detection for the vehicle 812 through use of the above-described thermal-augmented image object detection pipeline that harnesses a visible light image detector for purposes of processing both visible light images captured by the visible light sensor 818 and thermal images captured by the thermal image sensor 820, thereby providing robust, accurate, and fast object detection for the ADAS 826.

Any one or more of the processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It should be appreciated that any one or more of the computers discussed herein may include other memory, such as volatile RAM that is used by the processor, and/or multiple processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the word “enhancement”, “enhanced”, and its other forms are not to be construed as limiting the invention to any particular type or manner of image enhancement, but are generally used for facilitating understanding of the above-described technology, and particularly for conveying that such technology is used to address degradations of an image. However, it will be appreciated that a variety of image enhancement techniques may be used, and each image enhancement technique is a technique for addressing a specific degradation or class of degradations of an image, such as those examples provided herein.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of detecting an object within an image, comprising:
obtaining a thermal image captured by a thermal image sensor;
projecting the thermal image into a visible light color space to generate a projected thermal image; and
detecting an object within the projected thermal image through inputting the projected thermal image into a visible light object detector configured to detect objects within image data within the visible light color space.

2. The method of claim 1, wherein the visible light object detector is configured to detect objects within a visible light image captured by a visible light sensor, the projected thermal image captured by the thermal image sensor, or both the visible light image and the projected thermal image.

3. The method of claim 1, further comprising the step of: capturing a visible light image and inputting the visible light image into the visible light object detector in order to detect one or more objects located within the visible light image.

4. The method of claim 3, wherein the visible light image includes at least three visible light channels.

5. The method of claim 4, wherein at least three visible light channels include one or more of the following: a red channel, a green channel, a blue channel.

6. The method of claim 1, further comprising: upsampling the thermal image using a super-resolution technique to generate an upsampled thermal image, wherein the upsampled thermal image is projected to the visible light color space using a projection function to generate a projected thermal image, and wherein the projected thermal image is used as the upsampled thermal image for object detection.

7. The method of claim 6, wherein the projected thermal image is combined with a visible light image in order to detect an object visible within a shared field of view, and wherein the shared field of view is a field of view defined by overlapping of a field of view of the thermal image sensor and a field of view of a visible light sensor used to capture the visible light image.

8. The method of claim 1, further comprising the steps of: capturing a visible light image using a visible light sensor; and determining whether the visible light is degraded, wherein the upsampled thermal image is used for object detection when it is determined that the visible light image is degraded, and wherein the visible light image is used for object detection when it is determined that the visible light image is not degraded.

9. The method of claim 1, wherein the visible light object detector includes a bidirectional feature pyramid network and an object detector head.

10. A method of detecting an object within a thermal image, comprising:
obtaining a visible light image captured by a visible light sensor;
determining whether the visible light is degraded;
when it is determined that the visible light image is degraded:
projecting the thermal image into a visible light color space to generate a projected thermal image; and
detecting an object within the projected thermal image through inputting the projected thermal image into a visible light object detector; and
when it is determined that the visible light image is degraded, detecting an object within the visible light image through inputting the visible light image into the image object detector.

11. A thermal-augmented image object detection system, comprising:
a visible light sensor configured to capture a visible light image;
a thermal image sensor configured to capture a thermal image;
a computer subsystem having at least one processor and memory storing computer instructions that, when executed by the at least one processor, cause the thermal-augmented image object detection system to:
project the thermal image into a visible light color space to generate a projected thermal image; and
detect an object within a shared field of view by inputting one or both of the visible light image and the projected thermal image into a visible light object detector configured to detect objects within image data within the visible light color space.

12. The thermal-augmented image object detection system of claim 11, wherein the computer subsystem is further configured so that, when the computer instructions are executed by the at least one processor, the thermal-augmented image object detection system determines whether the visible light is degraded; and, when it is determined that the visible light image is degraded, to perform upsampling of the thermal image to generate the upsampled thermal image and to input the upsampled thermal image into the visible light object detector in order to detect objects.

13. The thermal-augmented image object detection system of claim 12, wherein the computer subsystem is further configured so that, when the computer instructions are executed by the at least one processor, the thermal-augmented image object detection system inputs the visible light image into the visible light object detector in order to detect objects.

14. The thermal-augmented image object detection system of claim 12, wherein the shared field of view is a field of view defined by overlapping of a field of view of the thermal image sensor and a field of view of a visible light sensor used to capture the visible light image.

15. The thermal-augmented image object detection system of claim 11, wherein the visible light image includes at least three visible light channels.

16. The thermal-augmented image object detection system of claim 15, wherein at least three visible light channels include one or more of the following: a red channel, a green channel, a blue channel.

17. The thermal-augmented image object detection system of claim 11, wherein the computer subsystem is further configured so that, when the computer instructions are executed by the at least one processor, the thermal-augmented image object detection system upsamples the thermal image using a super-resolution technique to generate an upsampled thermal image, wherein the upsampled thermal image is projected to the visible light color space using a projection function to generate a projected thermal image, and wherein the projected thermal image is used as the upsampled thermal image for object detection.

18. The thermal-augmented image object detection system of claim 17, wherein the projected thermal image is combined with a visible light image in order to detect an object visible within the shared field of view, and wherein the shared field of view is a field of view defined by overlapping of a field of view of the thermal image sensor and a field of view of a visible light sensor used to capture the visible light image.

19. A vehicle having vehicle electronics that include the thermal-augmented image object detection system of claim 11.

20. An advanced driver assistance system (ADAS) for a vehicle, comprising the thermal-augmented image object detection system of claim 11.
